(19) United States
(12) Patent Application Publication
(10) Pub. No.: US 2017/0286040 A1
(43) Pub. Date: Oct. 5, 2017

(54) DISPLAY AND OPERATING UNIT AND METHOD OF OPERATING A FIELD INSTRUMENT HAVING A DISPLAY AND OPERATING UNIT

(71) Applicant: SICK AG, Waldkirch (DE)

(72) Inventor: Martin BEHA, Waldkirch (DE)

(21) Appl. No.: 15/474,403

(22) Filed: Mar. 30, 2017

(30) Foreign Application Priority Data
Apr. 1, 2016 (DE) 102016106003.8

(51) Int. Cl. G06F 3/14; G06F 13/38; G06F 13/42; G06F 3/0484; G06F 9/44

(52) U.S. Cl. CPC G06F 3/14; G06F 3/04847; G06F 8/31; G06F 13/4282; G06F 13/385; G06F 17/2247

(57) ABSTRACT

A display and operating unit having a web application for operating a field instrument and a method of operating a field instrument having a display and operating unit having a web application, wherein the display and operating unit is connectable to the field instrument; wherein at least one parameter of the field instrument is visualized on the display and operating unit by means of the web application and a parameterization of the field instrument s made possible and the web application for the visualization and/or parameterization is executed in a browser; wherein the browser is executed on the display and operating unit; and wherein the browser and/or the web application has/have an interface with which direct access to components or operating system components of the display and operating unit, to components of the field instrument and/or to external units is carried out.

The present invention relates to a display and operating unit having a web application for operating a field instrument, wherein the display and operating unit is connectable to the field instrument; wherein at least one parameter of the field instrument is visualized on the display and operating unit by means of the web application and a parameterization of the field instrument is made possible and the web application for the visualization and/or parameterization is executed in a browser; and wherein the browser is executed on the display and operating unit. The invention further relates to a method of operating a field instrument having a display and operating unit having a web application, wherein the display and operating unit is connected to the field instrument; wherein at least one parameter of the field instrument is visualized on the display and operating unit by means of the web application and a parameterization of the field instrument is made possible and the web application for the visualization and/or parameterization is executed in a browser; and wherein the browser is executed on the display and operating unit.

A use of web technologies for generating and/or presenting a user interface for a field instrument on different human machine interface (HMI) units and/or displays in accordance with the prior art is hindered by security mechanisms on the use of a standard browser, e.g. Firefox or Chrome. Specific applications in operation can only be implemented in a convoluted manner with the aid of a local web server or by the installation of a browser plug-in. Direct access to the hardware of the HMI unit and/or of the display is above all not possible.

Direct hardware access, for example to a file system of a USB stick, by the browser is not easily possible, for example, in accordance with the prior art.

The use of a standard browser in the environment of an embedded system with limited resources is furthermore not recommended since a standard browser in accordance with the prior art required a powerful processor.

There are essentially the following solution approaches to bypass a browser restriction. First, the implementation of a browser plug-in. Second, the use of a signed Java applet, and third the use of a local web server on the client.

The browser plug-in must be separately implemented for different standard browsers, e.g. Firefox, Chrome, Internet Explorer. The plug-in concept especially differs from browser to browser. The browser implementation is complex by the use of a plug-in architecture since each browser has to be individually taken into account.

The use of Java applets is possibly associated with security risks since security holes have been discovered in connection with the use of Java applets. A Java VM (virtual machine) that makes a high demand on the hardware is furthermore required for the operation of a Java applet. In addition, the sole application purpose of Java as an interface is comparatively high.

These two approaches are based on the fact that a certain processing performance is required specifically with the use of Java. This required computing performance together with the required performance of a web engine would correspondingly overload an embedded system in dependence on the processor.

The use of a local web server brings an additional software component into play in the operation of the human machine interface. Respective queries and responses result in a corresponding administration effort and in a time delay. A web server is furthermore possibly open to attack in dependence on the implementation.

It is an object of the invention to provide an improved display and operating unit that can be connected to a plurality of field instruments or that can themselves be of different designs.

The object is satisfied in accordance with claim 1 by a display and operating unit having a web application for operating a field instrument, wherein the display and operating unit is connectable to the field instrument, wherein at least one parameter of the field instrument is visualized on the display and operating unit by means of the web application and a parameterization of the field instrument is made possible and the web application for the visualization and/or parameterization is carried out in a browser, wherein the browser is executed on the display and operating unit, wherein the browser and/or the web application has/have an interface that is configured to carry out direct access to components or to operating system components of the display and operating unit, to components of the field instrument and/or to external units.

The object is further satisfied by a method of operating a field instrument having a display and operating unit having a web application, wherein the display and operating unit is connected to the field instrument, wherein at least one parameter of the field instrument is visualized on the display and operating unit by means of the web application and a parameterization of the field instrument is made possible and the web application for the visualization and/or parameterization is carried out in a browser, wherein the browser is executed on the display and operating unit, wherein the browser and/or the web application has/have an interface with which direct access to components or to operating system components of the display and operating unit, to components of the field instrument and/or to external units is carried out.

The invention in particular relates to field instruments of process automation, that is, for example, an analyzer, a transmitter, in particular O₂ transmitters, field instruments for flue gas analysis such as particulate measuring instruments, spectrometers, laser scanners and the like.

The display and operating unit can, for example be a display having a touch screen property that can be operated merely by a finger. If a user wants to input user text data, a screen keyboard pops up, for example.

The display and operating unit is based on web technologies. The display and operating unit is, for example, hooked up to the field instrument or is directly connected to the field instrument. After the hook-up, the display and operating unit automatically electronically connects to the field instrument.

The invention makes possible direct access of the web application or of a program to the specific hardware of the display and operating unit. A quasi-minimal browser is implemented for this purpose.

A large advantage in the use of web technologies results in that the effort for a development of a user interface, is reduced. Once a web application has been developed, it can be used both in the display and operating unit and in a standard browser as well as in an app, that is an application for tablets and smartphones.

A uniform technology for different end devices is so-to-say used by the use of web technologies.

The restrictions of a standard browser can be bypassed by the implementation of the specific browser in accordance with the invention that is used in the display and operating unit.

In accordance with the invention, components or operating system components can be directly accessed via the web application.

In a further development of the invention, the field instrument has a web server. After hook-up, the display and operating unit automatically connects to the integrated web server of the field instrument. The web server of the field instrument provides the web application that is executed in the browser of the display and operating unit.

The web server is a server that transmits documents to the browser or web browser. A web server is the computer with the web server software or only the web server software itself in the field instrument.

The main object of the web server is the delivery of static files, e.g. unchangeable HTML files or image files, or dynamically generated files, e.g. pages whose contents are always prepared individually in accordance with the profile of the display and operating unit.

The web application is preferably written in HTML, JavaScript and CSS.

The hypertext markup language, abbreviated to HTML, is a text-based markup language for structuring digital documents such as texts with hyperlinks, images and other contents. HTML documents form the basis for the World Wide Web and are presented by web browsers. In addition to the contents displayed by the browser, HTML files can contain additional indications in the form of meta-information.

As a markup language, HTML serves to structure a text semantically, but not to format it. The visual presentation is not part of the HTML specifications and is determined by the browser or web browser and by design templates such as CSS.

JavaScript (abbreviation: JS) is a script language that was originally developed for dynamic HTML in web browsers to evaluate user interactions, to change, reload or generate contents, and thus to expand the possibilities of HTML and CSS.

The language core of JavaScript, standardized as ECMAScript (ECMA 262), describes a dynamically typified, object-oriented, but classless script language. It meets the demands of all object-oriented programming paradigms, inter alia on the basis of prototypes. Programming in JavaScript can be done in an object-oriented and both procedurally and functionally.

Cascading style sheets (CSS) is a stylesheet language for electronic documents and is, together with HTML and DOM, one of the core languages of the World Wide Web. It is a so-called living standard and is constantly further developed by the World Wide Web Consortium (W3C). Style instructions are prepared using CSS that are above all used together with the markup languages HTML and XML.

As a rule, the HTML page, including linked design descriptions (CSS) and image files (JPG, PNG. GIF, Flash), is respectively transmitted as individual files. The browser or web browser has to send a separate request to the web server for every file required.

With JavaScript, a web technology is used that directly supports the browser. No additional programs have to be used that are open to attack in some cases and no hardware having a specific performance such as Java VM or local web servers.

The implemented browser or the web application can furthermore have a very simple design since program components such as a plug-in management are not required. The minimal browser is reduced to the essential, namely the rendering and the display of HTML, CSS and JavaScript.

Use on an embedded system is possible. The term embedded system means an electronic processor or also a computer that is linked or embedded in a technical context. In this respect, the processor either takes over functions of monitoring, control or regulation or is responsible for a form of data or signal processing or for the display and operating unit.

Embedded systems are typically adapted to one task. An optimized mixed hardware/software implementation is selected for cost reasons. In this respect, such a design combines the great flexibility of software with the performance capability of the hardware. In this respect, the software serves both to control the system itself, that is the field instrument, and, optionally, for the interaction of the system with the outside world via defined interfaces or protocols.

In a further development of the invention, the interface is a JavaScript interface. The browser in accordance with the invention provides a specific JavaScript interface, in particular a specific JavaScript API, where API stands for an application program interface. This then e.g. allows direct access to the hardware of the display and operating unit. An additional web server on the display and operating unit itself is thus not required.

Access from the web application can then take place by JavaScript functions. Data can e.g. thus be stored directly or hardware can be addressed directly.

For direct access to the components or operating system components, a JavaScript interface is implemented that is adapted to the components or operating system components and that allows direct access from the web application. In the web application itself, it is easily possible to determine whether the JavaScript interface is available or not. Functions of the web application presented in the web interface can thus also appear or disappear accordingly if the JavaScript interface is not available.

The presence of the JavaScript interface can be determined in a simple manner and can thus have an influence on the presented functional extent of the web application.

The JavaScript interface is in this respect a fixed component of the minimal browser in accordance with the invention. The browser in accordance with the invention is called the minimal browser that is able to render HTML(5) in conjunction with CSS and to execute JavaScript code. Any functions not required are dispensed with in the implementation.

The especially developed browser has still further advantages. Other field instruments can be found directly since special scan programs can be integrated in the browser to execute an instrument scan whose result is provided to the program in the second step by JavaScript API.

The JavaScript API is used, for example, to show a native screen keyboard present in the operating system of the display and operating unit.

In a further development of the invention, the JavaScript interface has a web engine to execute JavaScript code. A web engine can also be synonymously called a JavaScript program or a JavaScript engine or a web engine with a JavaScript interpreter. A web engine can also be called an HTML renderer.

The JavaScript API of the web engine is expanded by its own JavaScript functions. The web engine used has to support a corresponding expansion concept.

A direct invocation of e.g. the function “sick_js_writeFile ( . . . )” can thus take place out of the web application that is written in HTML, JavaScript and CSS. This method is ultimately implemented in C++ and is compiled together with the total application, namely the browser. Direct access to the hardware is thus possible.

The same restrictions, with the exception of these accesses, apply with respect to the execution of the JavaScript code as for the execution in a standard browser.

The invocation of the special hardware access functions is preferably restricted to manufacturer-specific web applications or web programs. Security can thus be correspondingly increased.

In a further embodiment, the web engine has a program library. A program library designates a collection of subprograms/subroutines that provide solution approaches for thematically associated problems. Unlike web applications or programs, libraries are not independently executable units, but rather contain auxiliary modules that are requested by the web application.

The web engine is preferably implemented in the C++ programming language. C++ is a programming language standardized by the ISO. C++ enables both an efficient and machine-oriented programming and a programming at a high abstraction level. The standard also defines a standard library with respect to which different implementations exist.

The C++ language comprises a language core having very few keywords. It is given its actual function, in a similar manner also to the language C. by the C++ standard library as well as, depending on the field of application. additional libraries and frameworks. C++ has a focus on the language tools for developing libraries.

One of the strengths of C++ is the combination ability of efficient, machine-oriented programming with powerful language tools that combine simple to complex implementation details. In this respect, above all template metaprogramming is used, a technique that allows an almost compromise-free connection of efficiency and abstraction.

In a further development of the invention, the operating system components are drivers for a file system, drivers for the display and/or drivers for a network.

A device driver, frequently just called a driver, is a computer program or software module that controls the interaction with connected installed hardware or virtual devices. For this purpose, the driver, on the one hand, typically communicates directly with the device, namely the display and operating unit or the field instrument, and exchanges control signals or data with the device, via the communication bus, for example a hardware interface or a bass communication system of the operating system. On the other hand, the driver provides the operating system and/or the web application or the application software with a standardized interface such that this specific device can be addressed in the same manner as similar devices of other manufacturers.

The main task of device drivers is the provision of hardware-oriented functions by a hardware abstraction level. Many kinds of devices are different, even devices that satisfy the same purpose. Even the different models of a field instrument of the same manufacturer that, for example have new functions or greater performance, are frequently controlled completely differently.

It cannot be expected of computers and their operating systems that they can cope with all these different types, especially not with future devices. To solve this problem, the operating system defines how a call of devices should be addressed. The device drivers then take care of the translation of these function invocations of the operating system into device-specific control signals. A completely new device with a completely new control should therefore thus also work without problem as soon as a driver for this device is present. The operating It can address it with the same function invocations as any other device.

There are often many different variants of a driver, primarily in dependence on the supported hardware, often also in different versions. In addition, there has to be a variant for every supported operating system since the interfaces hereto, for example, differ greatly in different operating systems. There is furthermore a dependency on the basic architecture of the computer and of the operating system, also on the processing bandwidth. If no driver is present for a specific operating system or architecture, a corresponding environment can be emulated under certain circumstances, that is further abstraction levels can be added.

A hardware component is therefore useless without a suitable driver if it does not work autonomously and is dependent on support by software.

For example, a contrast or a brightness setting for the display and operating unit can be set. A driver is provided for the display and operating unit for this purpose to carry out the contrast or a brightness setting.

The display and operating unit is preferably an engineering tool, a smartphone, a table PC, a notebook or a desktop PC.

The integrated web server can also be invoked on a smartphone, a tablet PC, a notebook or a desktop PC by browser, provided that there is likewise a connection between the display and operating unit and the field instrument for example by Ethernet or wireless LAN. The most varied devices can be utilized despite the use of a uniform technology, namely the web technology.

In a preferred embodiment, the display and operating unit is connected to the field instrument via an Ethernet connection. Ethernet is a technology that specifies software, namely protocols, etc., and hardware, namely cables, distributors, network cards, etc. for cabled data networks, that was originally intended for local data networks (LANs) and is therefore also called a LAN technology. It allows the exchange of data in the form of data frames between the devices connected in a local network (LAN). Currently, transmission rates of 10 megabits/s, 100 megabits/s (fast Ethernet), 1000 megabit/s (gigabit Ethernet, 10, 40 and 100 gigabits/s are specified. Ethernet via glass fiber has a range of 10 km and more.

In a further development, the external unit is a mobile, pluggable USB memory. USB mass storage devices are devices that communicate via the universal serial bus (USB) and have an installed data store and are primarily used as removable media. They are frequently used in the form of USB memory sticks, known in abbreviated form and in general as USB sticks.

The invention will also be explained in the following with respect to further advantages and features with reference to the enclosed drawing and to embodiments. The FIGURES of the drawing show in:

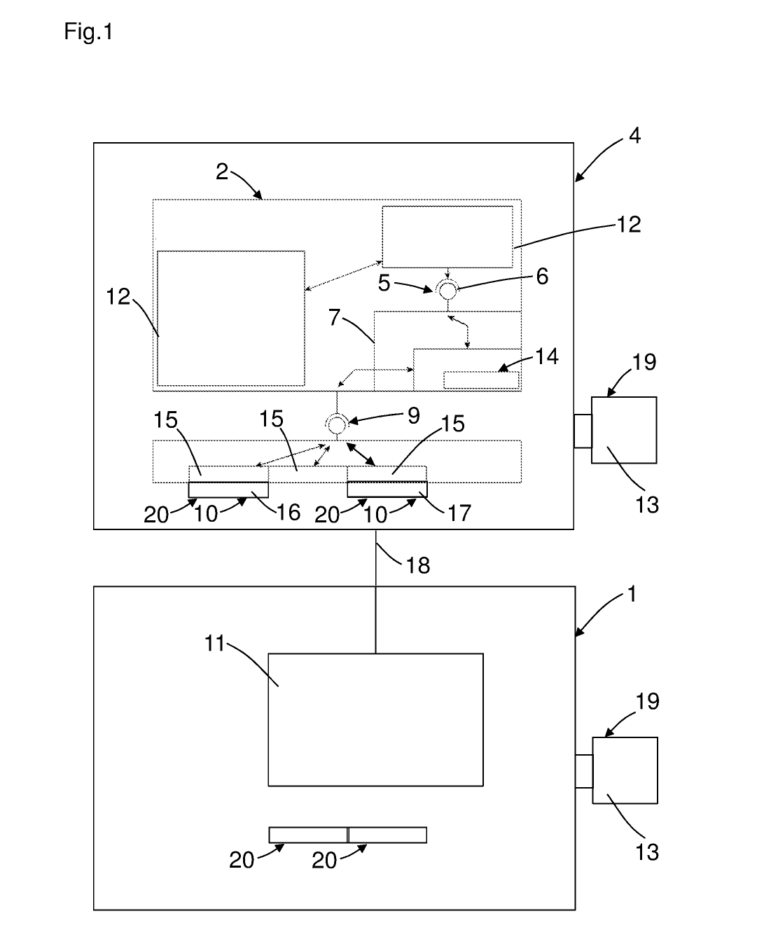

FIG. 1 a display and operating unit having a web application for operating a field instrument.

In the following FIGURES, identical parts are provided with identical reference numerals.

FIG. 1 shows a display and operating unit 4 having a web application 12 for operating a field instrument 1, wherein the display and operating unit 4 is connectable to the field instrument 1, wherein at least one parameter of the field instrument 1 is visualized on the display and operating unit 4 by means of the web application 12 and a parameterization of the field instrument 1 is made possible and the web application 12 for the visualization and/or parameterization is carried out in a browser 2, wherein the browser 2 is executed on the display and operating unit 4, wherein the browser 2 and/or the web application 12 has/have an interface 5 that is configured to carry out direct access to components 20 or to operating system components 10 of the display and operating unit 4, to components 20 of the field instrument 1 and/or to external units 13. In accordance with FIG. 1, the external unit 13 is a mobile pluggable USB memory 19.

The display and operating unit 4 is, for example, hooked up to the field instrument 1 or is directly connected to the field instrument 1. After the hook-up, the display and operating unit 4 automatically electronically connects to the field instrument 1.

The browser 2 allows direct access of the web application 12 or of the program to the specific hardware of the display and operating unit 4.

In accordance with FIG. 1, the field instrument 1 has a web server 11. After hook-up, the display and operating unit 4 automatically connects to the integrated web server 11 of the field instrument 1. The web server 11 of the field instrument 1 provides the web application 12 that is executed in the browser 2 of the display and operating unit 4.

The minimal browser 2 is reduced to the essential, namely the rendering and the display of HTML, CSS and JavaScript. In accordance with FIG. 1, the interface 5 is a JavaScript interface 6.

The browser 2 provides a special JavaScript interface 6, in particular a special JavaScript API. This then e.g. allows direct access to the hardware of the display and operating unit 4.

Access from the web application 12 can then take place by JavaScript functions. Data can thus e.g. be stored directly or hardware, namely a file system 16 or a network 17, can be addressed directly.

For direct access to the components 20 or operating system components 10, the JavaScript interface 6 is implemented that is adapted to the components 20 or operating system components 10 and that allows direct access from the web application 12.

The JavaScript interface 6 is in this respect a fixed component of the minimal browser 2. The browser 2 is called the minimal browser that is able to render HTML(5) in conjunction with CSS and to execute JavaScript code. Any functions not required are dispensed with in the implementation.

The especially developed browser 2 has still further advantages. Other field instruments 1 can be found directly since special scan programs can be integrated in the browser 2 to execute an instrument scan whose result is provided to the program 12 in the second step by JavaScript API.

In accordance with FIG. 1, the JavaScript interface 6 has a web engine 7 to execute JavaScript code. In accordance with FIG. 1, the web engine 7 has a program library 14.

In accordance with FIG. 1, the operating system components 10 are drivers 15 for a file system 16, drivers 15 for the display and operating unit 4 or a display and/or drivers 15 for a network 17. The drivers can, for example, be addressed via an operating system interface 9.

For example, a contrast or a brightness setting for the display and operating unit 4 or the display can be set. The driver 15 is provided for the display and operating unit 4 for this purpose to set the contrast or carry out a brightness setting.

The display and operating unit 4 is preferably an engineering tool, a smartphone, a table PC, a notebook or a desktop PC.

The integrated web server 11 of the field instrument 1 can also be invoked on a smartphone, a tablet PC, a notebook or a desktop PC by browser, provided that there is likewise a connection between the display and operating unit 4 and the field instrument 1 for example by Ethernet 18 or wireless LAN. In accordance with FIG. 1, the display and operating unit 4 is connected to the field instrument 1 via an Ethernet connection 18.

### REFERENCE NUMERALS

1 field instrument
2 browser
4 display and operating unit
5 interface
6 JavaScript interface
7 web engine
8 operating system
9 operating system interface
10 operating system component
11 web server
12 web application
13 external unit
14 program library
15 driver
16 file system
17 network
18 Ethernet connection
19 mobile pluggable USB memory
20 component

1. A display and operating unit having a web application for operating a field instrument, wherein the display and operating unit is connectable to the field instrument; wherein at least one parameter of the field instrument is visualized on the display and operating unit by means of the web application and a parameterization of the field instrument is made possible and the web application for the visualization and/or parameterization is executed in a browser; and wherein the browser is executed on the display and operating unit,
wherein at least one of the browser and the web application has an interface that is configured to carry out direct access to components or operating system components of the display and operating unit, to components of the field instrument and/or to external units.

2. The display and operating unit in accordance with claim 1, wherein the field instrument has a web server.

3. The display and operating unit in accordance with claim 1, wherein the web application is written in HTML, JavaScript and CSS.

4. The display and operating unit in accordance with claim 1, wherein the interface is a JavaScript interface.

5. The display and operating unit in accordance with claim 1, wherein the display and operating unit has a web engine and a JavaScript interface for executing JavaScript code.

6. The display and operating unit in accordance with claim 1, wherein the web engine has a program library.

7. The display and operating unit in accordance with claim 1, wherein the web engine is implemented in the programming language C++.

8. The display and operating unit in accordance with claim 1, wherein the operating system components comprise at least one driver for a file system, at least one driver for the display and operating unit and/or at least one driver for a network.

9. The display and operating unit in accordance with claim 1, wherein the display and operating unit is an engineering tool, a smartphone, a tablet PC, a notebook or a desktop PC.

10. The display and operating unit in accordance with claim 1, wherein the display and operating unit is connected to the field instrument via an Ethernet connection.

11. The display and operating unit in accordance with claim 1, wherein the external unit is a mobile pluggable USB memory.

12. A method of operating a field instrument having a display and operating unit having a web application, wherein the display and operating unit is connected to the field instrument; the method comprising the steps of:
visualizing at least one parameter of the field instrument on the display and operating unit by means of the web application;
making possible a parameterization of the field instrument; and
executing the web application for the visualization and/or parameterization in a browser;
wherein the browser is executed on the display and operating unit, wherein at least one of the browser and the web application has an interface with which direct access to components or operating system components of the display and operating unit, to components of the field instrument and/or to external units is carried out.

13. The method of operating a field instrument in accordance with claim 12, wherein the JavaScript interface has a web engine for executing JavaScript code.

14. The method of operating a field instrument in accordance with claim 12, wherein the display and operating unit is connected to the field instrument via an Ethernet connection.

15. A method of operating a field instrument having a display and operating unit having a web application in accordance with at least one of the preceding claim 1, wherein the display and operating unit is connected to the field instrument via an Ethernet connection.
